(19) United States
(12) Patent Application Publication
(10) Pub. No.: US 2026/0239227 A1
(43) Pub. Date: Aug. 13, 2026

(54) LOCATION-BASED WIRELESS POWER CONTROL IN A TIERED NETWORK

(71) Applicant: Charter Communications Operating, LLC, St. Louis, MO (US)

(72) Inventor: Rauf Hafeez, Cary, NC (US)

(21) Appl. No.: 19/049,341

(22) Filed: Feb. 10, 2025

(51) Int. Cl. H04W 52/28; H04W 52/24; H04W 64/00

(52) U.S. Cl. CPC H04W 52/283; H04W 52/242; H04W 52/243; H04W 64/00

(57) ABSTRACT

A wireless system as discussed herein includes a communication management resource such as associated with a first wireless station. The communication management resource determines a first location where the first wireless station resides in a network environment. The communication management resource further receives control information. The control information is derived based on a second location where a second wireless station resides in the network environment. The communication management resource determines a wireless power level at which to transmit first wireless communications from the first wireless station in the network environment based on a combination of the first location and the control information.

### BACKGROUND

The CBRS (Citizens Broadband Radio Service) band comprises 150 MHz of spectrum in the 3550 MHz to 3700 MHz range (3.5 GHz to 3.7 GHz) that the Federal Communications Commission (FCC) has designated for sharing among three tiers of users: incumbent users, priority access license (PAL) users and general authorized access (GAA) users.

Conventional wireless networks typically include one or more wireless base stations to provide mobile communication devices access to a remote network such as the Internet. One type of wireless base station is a so-called CBSD (Citizen Broadband Radio Service Device). Such a device uses a wireless channel allocated from a CBRS (Citizens Band Radio Service) band to support communications with one or more mobile communication devices.

Typically, so-called SAS (Spectrum Access Service) in a CBRS network allocates one or more wireless channels to a CBSD (such as a wireless base station) to support communications with respective user equipment such as one or more mobile communication devices. Each base station can be configured to communicate with the SAS to receive notification of the one or more wireless channels allocated for its use. Controlled allocation of wireless channels by the spectrum access system helps to prevent interference by wireless stations sharing use of the same spectrum.

As previously discussed, there are multiple different types of wireless channels in a conventional CBRS band. For example, portions of spectrum in a CBRS band include so-called Priority Access License (PAL) wireless channels, General Authorized Access (GAA) wireless channels, or a combination of both.

In general, PAL wireless channels are licensed wireless channels in which a corresponding licensee (such as an entity paying for use of the wireless channel) is provided some protection of use. For example, when no incumbent user requires use of the channels, in theory, the licensed entity is able to freely use the PAL wireless channels in respective one or more predetermined geographical regions without interference by other lower priority entity users (such as lower priority GAA users).

In a CBRS band, a conventional centralized controller called a spectrum access system (a.k.a., SAS) enables sharing of wireless bandwidth by multiple wireless stations operating in the same geographical region via implementation of radio frequency propagation models. Implementation of the wireless signal propagation models protects users from harmful interference.

### BRIEF DESCRIPTION OF EXAMPLES

This disclosure includes the observation that:
Propagation models implemented in conventional systems are generally conservative, resulting in inefficient spectrum sharing among users.
Dynamic spectrum sharing (DSS) via a conventional system enables spectrum sharing among spectrum users by sensing noise/interference actually present in the environment.
A sensor placed in the vicinity of a high priority entity requiring protection provides feedback to other wireless stations in the network environment through a communication interface such as an informing portal to lower or increase their wireless emissions as needed to protect the higher priority entity.
Mobile communication devices can be configured to adapt their emissions to protect high-priority entities requiring protection based on control information received from the portal.

Techniques herein include novel ways of providing better use of available wireless channels, without causing or at least reducing a magnitude of wireless interference to high priority entities operating in a network environment.

More specifically, as discussed herein, a communication management resource such as associated with a first wireless station (such as a wireless base station or other suitable entity) determines a first location where the first wireless station resides in a network environment. The communication management resource (wireless base station) receives control information from any suitable entity in the network environment. In one example, the control information is derived based on a second location where a second wireless station resides in the network environment. The second wireless station may be a high priority entity in a tiered hierarchy, where the second wireless station is disposed higher in the hierarchy and where the second wireless station has higher priority access rights to use a wireless channel than the first wireless station. The communication management resource determines a wireless power level at which to transmit first wireless communications (such as over the wireless channel) from the first wireless station in the network environment based on the first location and the control information.

In one example, the control information indicates a wireless power threshold level value WPTL. The wireless power threshold level value WPTL is a wireless threshold level selected to protect the second wireless station from wireless interference caused by the first wireless station transmitting the first wireless communications.

As further discussed herein, the communication management resource can be configured to determine the wireless power level at which it is able to transmit wireless communications in any suitable manner. In one example, the control information indicates a third location, which may be in a vicinity of the second wireless station at the second location. The communication management resource estimates, such as via a path loss model (a.k.a., path loss information), a wireless signal path loss value PLV based on the location of the first wireless station with respect to the third location as specified by the control information. In a further example, the third location is different than the second location. The estimated path loss value PLV generated by the communication management resource or other suitable entity indicates an estimated path loss (such as indicating an amount of attenuation of a transmitted wireless signal that occurs during transmission of the wireless signal) between the first location and the second location. As further discussed herein, the communication management resource or other suitable entity calculates the wireless power level at which to transmit the first wireless communications from the first wireless station based on a combination of the estimated path loss as indicated by the path loss value PLV and the wireless power threshold level WPTL.

In yet a further example, the calculated wireless power level is an initial wireless power level TxPWR at which the first wireless station initially transmits the first wireless communications. In one example, the initial wireless power level is calculated as follows:

$$TxPWR = WPTL - TxANTGAIN - PLV ,$$

where TxANTGAIN represents a gain associated with antenna hardware at the first wireless station transmitting the first wireless communications.

Still further, examples herein include the first wireless station transmitting the first wireless communications at the determined wireless power level from the first wireless station. The first wireless communications may be encoded by the first wireless station or other suitable entity for delivery to a third wireless station in the network environment. Transmission of the first wireless communications at or below the determined wireless power level protects the second wireless station from interference caused by the first wireless station transmitting the first wireless communications.

It is further noted that, subsequent to transmitting the first wireless communications, the first wireless station may receive control commands from a management entity monitoring the magnitude of receiving the transmitted first wireless communications at a wireless sensor in a vicinity of the second wireless station. The control commands can be configured to control a magnitude of second wireless communications transmitted from the first wireless station to the third wireless station. For example, the first wireless station can be configured to transmit the second wireless communications in accordance with the control commands received from the management entity. In such an instance, the control commands ensure that the second wireless communications do not cause wireless interference to the second wireless station, which may be in a vicinity of the wireless sensor.

Note that the control information supplied by the allocation management resource as discussed herein can be configured to include any information. In still further examples, the control information received by the first wireless station may indicate different zone regions (such as an overlay of different zone regions over a geographical region or map of interest where the first wireless station and the second wireless station reside) in the network environment, where each of the different zone regions is assigned a wireless power level value for wirelessly transmitting in the network environment. In one example, the different zone regions as specified by the control information include a first zone region assigned a first wireless power level and a second zone region assigned a second wireless power level.

When determining the wireless power level at which to transmit the first wireless communications using the zone information including different zone regions, assume that the first wireless station detects that the first location (location of the first wireless station) resides within the second zone region of the different zone regions as specified by the control information. In response to the communication management resource or other suitable entity detecting that the first wireless station resides in the second zone region (including mapping of the location of the first wireless station to the second zone region and corresponding assigned second wireless power level), the first wireless station transmits the first wireless communications at the second wireless power level to the third wireless station. Transmission of the first wireless communications at the second wireless power level supports wireless connectivity between the first wireless station and the third wireless station, but prevents wireless interference with/to the second wireless station.

Techniques as discussed herein are useful over conventional techniques. For example, implementation of the system and corresponding operations as discussed herein provides better use of a respective wireless channels to convey data between wireless stations without causing undesirable interference to a wireless station having highest priority rights to use the one or more shared wireless channels.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are also directed to a method, system, computer program product, etc., that supports operations as discussed herein.

One example as further discussed herein includes a computer readable storage medium and/or system having instructions stored thereon. The instructions, when executed by the computer processor hardware, cause the computer processor hardware (such as one or more co-located or disparately processor devices or hardware) to: determine a first location where the first wireless station resides in a network environment; receive control information, the control information derived based on a second location where a second wireless station resides in the network environment; and determine a wireless power level at which to transmit first wireless communications from the first wireless station in the network environment based on the location of the first wireless station and the control information.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless connectivity in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more inventive concepts as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment and implementation of one or more wireless access points with respect to the operation of a high priority wireless station as discussed herein.

FIG. 2 is an example diagram illustrating control information to control transmission of wireless signals from one or more wireless stations as discussed herein.

FIG. 3 is an example diagram illustrating determination of a wireless power level at which to transmit wireless communications from the first wireless base station in the network environment based on a determined path loss and received control parameters as discussed herein.

FIG. 4 is an example diagram illustrating a first instance of different zone regions and corresponding assigned wireless power level information used to control wireless transmission of communications in the network environment from different zone regions as discussed herein.

FIG. 5 is an example diagram illustrating a second instance of different zone regions and corresponding assigned wireless power level information used to control wireless transmission of communications from different zone regions in the network environment as discussed herein.

FIG. 6 is an example diagram illustrating example computer hardware and software operable to execute operations as discussed herein.

FIG. 7 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

This disclosure includes the observation that there is a problem associated with conventional implementation of sharing use of wireless channels in a network environment. For example, when implementing conventional techniques, it is observed that a user may transmit at full power over an assigned first wireless channel when starting up, resulting in excessive interference to an incumbent entity (or licensed user), and further resulting in the incumbent entity tightening the interference protection threshold too much for all other users of the spectrum. This results in an unfair sharing framework, where some users may cause excessive interference while other users cause very little interference to an incumbent.

The disclosure as discussed herein includes novel implementation of wireless channel usage based on one or more of the following techniques:
The solution as discussed herein can be configured to use incumbent location information as a basis to enable fair spectrum sharing among users of a decentralized sharing framework.
A wireless base station as discussed herein can be configured to receive protection threshold information and location for an incumbent or its associated sensor from an informing portal. The exact location of the high priority incumbent entity may be protected from wireless interference or the exact location of the corresponding sensor disposed in a vicinity of the high priority incumbent entity may be obfuscated by adding some random error to its location.
Using a path loss model, the base station can be configured to calculate the radio frequency path loss between its antenna and the incumbent antenna using the location information.
The base station can be configured to determine its antenna gain toward the incumbent wireless station.
Using the path loss, antenna gain, and incumbent protection threshold, the base station can be configured to determine the maximum transmit power it can use while protecting the incumbent.
The base station can be configured to receive protection threshold information for other incumbents and licensed users requiring protection.
The base station as discussed herein can be configured to determine the maximum transmit power for each incumbent and licensed user.
The base station can be configured to implement a wireless transmit power level for transmitting communications, where the wireless transmit power level is lower than each of the maximum transmit powers.
The base station may also adjust one or more of its transmission parameters to meet the protection thresholds for all incumbent entity and licensed users-Antenna downtilt, beamforming, beam nulling, PRB blanking, etc.

Accordingly, a wireless system as discussed herein includes multiple wireless stations such as a first wireless station and a second wireless station in a network environment. The first wireless station determines a first location where the first wireless station resides in a network environment. The first wireless station further receives control information. The control information is derived based on a second location where the second wireless station resides in the network environment. The first wireless station determines a maximum wireless power level at which to transmit one or more wireless communications from the first wireless station in the network environment based on the location of the first wireless station and the control information.

In one example, the determination of the maximum wireless power level for transmitting the one or more wireless communications from the first wireless station is based on a path loss between the first wireless station and the second location.

Alternatively, the determination of the wireless power level for transmitting the one or more wireless communications from the first wireless station is based on different zone regions as indicated in the received control information. In such an instance, the determination of the wireless power level includes determining which of the different zone regions in which the first wireless station resides and then transmitting the first wireless communications from the first wireless station at or below a power level assigned to the zone region in which the first wireless station resides.

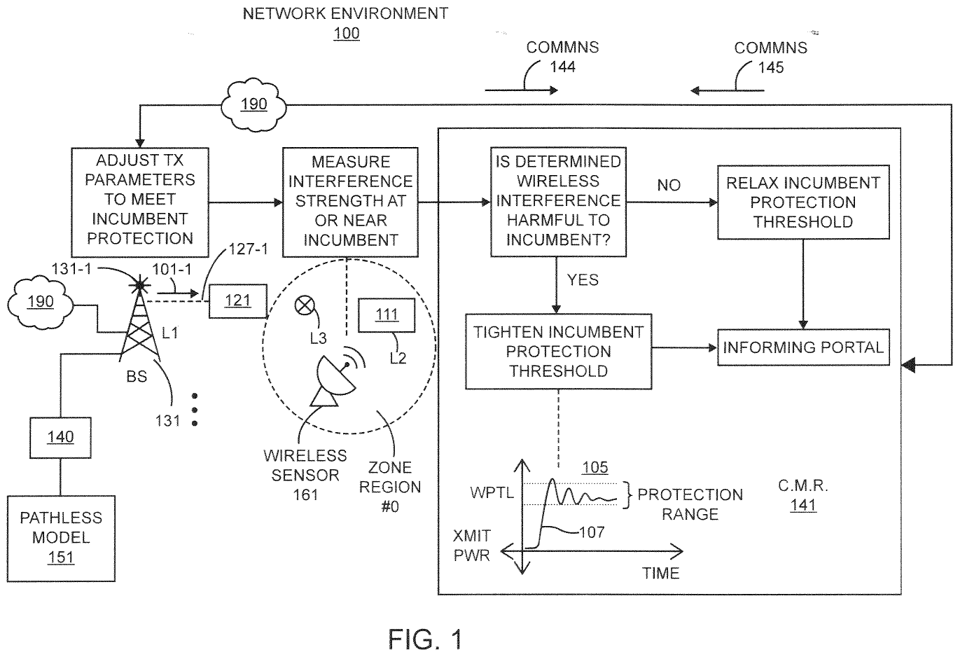

Now, more specifically, FIG. 1 is an example diagram illustrating a wireless network environment and operation of one or more wireless stations with respect to operation of one or more high priority wireless stations as discussed herein.

As shown in FIG. 1, the network environment 100 includes wireless base station 131, remote network 190, communication management resource 140, path loss model 151 (a.k.a., path loss information), mobile communication device 121 (a.k.a., user equipment), wireless sensor 161, wireless station 111, and communication management resource 141 (such as an allocation management resource or other suitable entity).

In general, the wireless base station 131 resides at the location L1 (such as a fixed location) in the network environment 100. Via communications over the wireless communication link 127-1, the wireless base station 131 provides the mobile communication device 121 wireless access to the remote network 190. For example, the wireless communication link 127-1 supports conveyance of wireless communications 101-1 transmitted between the wireless base station 131 and the mobile communication device 121.

The wireless base station 131 can be configured to communicate with any number of mobile communication devices present in the network environment 100

The wireless base station 131 can be configured to communicate with the mobile communication device 121 in accordance with any suitable wireless communication protocol or any suitable wireless channels.

In one example, the communication management resource 141 is an allocation management resource (or spectrum access system) in communication with the wireless base station 131. The communication management resource 141 allocates any of multiple wireless channels in a wireless band (such as a so-called CBRS band, where CBRS stands for Citizens Broadband Radio Service) or other suitable wireless bandwidth for use by the wireless base station 131. CBRS is in the 3.5 GHz band, which ranges from 3550 MHz to 3700 MHz.

The one or more wireless channels allocated for use by the wireless base station 131 and corresponding mobile communication device 121 may be licensed wireless channels or general access channels.

Use of the wireless channels by the different wireless stations in the network environment 100 may be based on a tiered hierarchy in which the high priority wireless station 111 (such as a so-called incumbent entity) has the highest priority rights over any wireless stations operated in the network environment 100. This means that the lower priority wireless stations such as including wireless base station 131 and mobile communication device 121 must not transmit wireless signals that would cause interference to the high priority wireless station 111. In other words, the wireless base station 131 and mobile communication device 121 are prevented from transmitting signals 101-1 at such high wireless power levels that it causes wireless interference to the high priority wireless station 111.

Thus, in one example, the high priority wireless station 111 is a so-called incumbent entity having higher priority rights to use wireless channels in the network environment 100 over any other lower priority wireless stations such as wireless base station 131, mobile communication device 121, etc.

In certain instances, the wireless base station 131 and mobile communication device 121 may be required to discontinue transmitting all wireless communications in a wireless channel used by the high priority wireless station 111. Techniques herein enable coexistence of the wireless base station 131 and mobile communication device 121 using a wireless channel also use by the high priority wireless station 111.

As further shown, the wireless base station 131 includes communication management resource 140. As its name suggests, the communication management resource 140 manages control of the wireless base station 131 so that the wireless base station 131 does not wirelessly interfere with the high priority wireless station 111 operating in the network environment 100.

Note that the resources as discussed herein can be implemented in any suitable manner. For example, the communication management resource 140 can be implemented as communication management hardware, communication management software, or a combination of communication manager hardware and communication management software; the path loss model 151 can be implemented as path loss model hardware, path loss model software, or a combination of path loss model hardware and path loss model software; wireless base station 131 can be implemented as wireless base station hardware, wireless base station software, or a combination of wireless base station hardware and wireless base station software; mobile communication device 121 can be implemented as mobile communication device hardware, mobile communication device software, or a combination of mobile communication device hardware and mobile communication device software; wireless sensor 161 can be configured as wireless sensor hardware, wireless sensors software, or a combination of wireless sensor hardware and wireless sensor software; high priority wireless station 111 can be implemented as high priority wireless station hardware, high-priority wireless station software, or a combination of high priority wireless station hardware and high-priority wireless station software; communication management resource 141 can be configured as communication management hardware, communication management software, or combination of communication management hardware and communication management software; and so on.

This disclosure includes the observation that it is desirable to control an initial wireless power level or subsequent wireless power level of transmitting wireless communications 101-1 from the wireless base station 131 to the mobile communication device 121 such that the high priority wireless station 111 does not experience wireless interference above a threshold level based on the retransmitted wireless communications 101-1.

Accordingly, in this example, assume that the wireless base station 131 communicates over the network 190 such as via communications 144 for allocation of a wireless channel to communicate in the network environment 100. In response to the request for allocation of wireless channel, via communications 145, the communication management resource 141 notifies the wireless base station 131 that it has been allocated use of a first wireless channel (wireless channel #1) to support wireless indications between the wireless base station 131 and the mobile communication device 121.

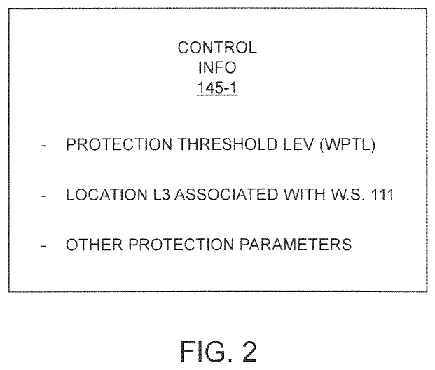

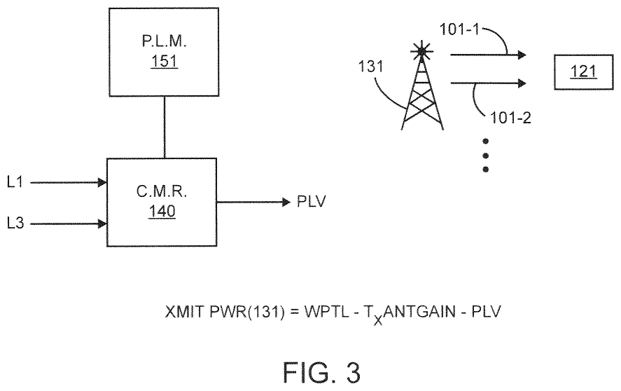

In one example, prior to the wireless base station 131 communicating with the mobile communication device 121 via the wireless channel #1, the communication management resource 140 and corresponding wireless base station 131 implement the operations as shown in corresponding FIGS. 1, 2, and 3 to control the initial or subsequent wireless power level of transmitting wireless communications 101-1 to the mobile communication device 121. In general, FIG. 2 is an example diagram illustrating control information to control transmission of wireless signals from one or more wireless stations as discussed herein. FIG. 3 is an example diagram illustrating determination of a wireless power level at which to transmit wireless communications from the first wireless base station in the network environment based on a determined path loss and received control parameters as discussed herein.

With reference to a combination of FIGS. 1, 2, and 3, the wireless base station 131 and corresponding communication management resource 140 receive communications 145 from the communication management resource 141. The communications 145 transmitted from the communication management resource 141 to the wireless base station 131 can be configured to include the control information 145-1 (FIG. 2).

As shown in FIG. 2, the control information 145-1 can be configured to include protection threshold level information WPTL (which stands for wireless protection threshold level), location information L2 indicating a location associated with the wireless station 111 or location L3 that is located in a nearby vicinity of the location L2, and other protection parameters potentially implemented by the wireless base station 131.

In one example, the location L3 used by the wireless base station 131 is a location nearby the location of the high priority wireless station 111. It may be desirable to prevent distribution of information indicating the location of the high priority wireless station 111. Thus in the latter instance, providing notification of the location L3, which is only in a vicinity of the wireless station 111 and corresponding location L2, does not give away the location of the high-priority wireless station 111. Alternatively, if desired, the control information 145-1 can be configured to include the location L2 indicating the current location of the high-priority wireless station 111.

Further in this example, the wireless protection threshold level WPTL is a value representing a maximum amount of wireless energy that should be present at the location L3 (or location L2) associated with the wireless base station 131 transmitting the wireless communications 101-1 to the mobile communication device 121 or other suitable entity. In other words, it is desirable that the wireless power level of any wireless signals transmitted by the wireless base station 131 as measured at the location L2 or location L3 is below the wireless protection threshold level WPTL. An example of preventing the wireless power level from being above the wireless protection threshold level at location L2 or location L3 is further discussed below.

More specifically, the wireless base station 131 and corresponding communication management resource 140 can be configured to determine a path loss (PLV) between the wireless base station 131 and the location L3 using the assigned wireless channel #1. The wireless base station 131 can be configured to transmit the communications 101-1 and appropriate power level XMITPWR(131) such that a magnitude of the wireless power level associated with the transmitted wireless communications 101-1 as received at location L2 or L3 is less than or equal to the wireless protection threshold level WPTL.

Now, with reference to FIG. 3, the communication management resource 140 such as associated with the wireless base station 131 (such as a first wireless station) receives first location information L1 indicating the fixed location where the wireless base station 131 resides in the network environment 100. The communication management resource also receives control information 145-1 as previously discussed.

The control information 145-1 may be derived based at least in part on a second location L2 where a second wireless station resides in the network environment 100. In other words, the location L3 may be derived at least in part from location L2. The communication management resource 140 and corresponding wireless base station 131 determine a wireless power level such as XMITPWR(131) at which to transmit first wireless communications 101-1 from the wireless base station 131 in the network environment 100 based on the first location L1 associated with the wireless base station 131 and the settings (including location L3) as specified by the control information 145-1.

In one example, as previously discussed, the control information 145-1 indicates a wireless power threshold level value WPTL. The wireless power threshold level value WPTL is a wireless threshold level selected to protect the high priority wireless station 111 (such as a second wireless station) from wireless interference caused by the wireless base station 131 transmitting the first wireless communications 101.

Further, as previously discussed, the communication management resource 140 and corresponding wireless base station 131 can be configured to determine the wireless power level XMITPWR(131) for transmitting over wireless channel #1 in any suitable manner. In one example, the control information 145-1 indicates a third location L3, which may be in a vicinity of the second wireless station at the second location L2. The communication management resource 141 estimates, such as via a path loss model 151 (any suitable path loss information), a wireless signal path loss value PLV based on the location of the wireless base station 131 with respect to the third location L3 as specified by the control information 145-1. The determined amount of path loss is based at least in part on a distance between the location L1 (of the wireless base station 131) and the location L3. The path loss may also account for any wireless signal blocking objects disposed in a wireless path between the wireless base station 131 in the high priority wireless station 111 or location L3. The blocking objects will increase the determined path loss.

In a further example, as previously discussed, the third location L3 is different than the second location L2. The third location L3 is sufficiently close a vicinity to the location L2 such that the path loss between the wireless base station 131 and the third location L3 is substantially equal to the path loss between the wireless base station 131 and the second location L2. Again, use of the location information L3 instead of L2 prevents the wireless base station 131 or other entities from knowing an exact location of the high priority wireless station 111.

Thus, the estimated path loss value PLV generated by the communication management resource 140 or other suitable entity substantially indicates an estimated path loss between the first location L1 and the second location L2.

Note further that the communication management resource 140 or other suitable entity can be configured to calculate the maximum wireless power level XMITPWR(131) at which to transmit the first wireless communications 101-1 over wireless channel #1 from the wireless base station 131 based on a combination of the estimated path loss (between the wireless base station 131 and the high-priority wireless station 111) as indicated by the path loss value PLV and the wireless power threshold level WPTL. More specifically, in one example, the communication management resource 140 can be configured to calculate the initial wireless power level TxPWR (131) at which the wireless base station 131 transmits the first wireless communications 101-1. The initial wireless power level maybe calculated as follows:

$$TxPWR ( 131 ) = WPTL - TxANTGAIN - PLV , \qquad ( equation 1 )$$

where TxANTGAIN represents a gain associated with antenna hardware 131-1 implemented at the wireless base station 131 that is used to transmit the wireless communications 101-1 and any subsequent vacations to the mobile communication device 121.

Subsequent to generating the initial transmit power level TxPWR (131), the wireless base station 131 transmits the wireless communications 101-1 at the determined power level TxPWR (131) from the wireless base station 131. The high-priority wireless station 111 also uses the wireless channel #1 to support communications with one or more other wireless stations in the network environment 100

Note that the first wireless communications 101-1 may be encoded by the first wireless base station 131 or other suitable entity for delivery of the wireless communications 101-1 to a third wireless station such as the mobile communication device 121 in the network environment 100. As previously discussed, transmission of the first wireless communications 101-1 at the determined wireless power level TxPWR (131) protects the high-priority wireless station 111 (which also uses wireless channel #1 or potentially the adjacent wireless channels such as wireless channel #2) from unwanted wireless interference (such as co-channel or adjacent channel interference) caused by the wireless base station 131 transmitting the first wireless communications 101-1.

With further reference to FIG. 1 and FIG. 3, it is further noted that, subsequent to transmitting the first wireless communications 101-1, via further communications 145 from the communication management resource 141, the wireless base station 131 may receive control commands from a management entity such as the communication management resource 141 monitoring the magnitude of receiving the transmitted first wireless communications 101-1 at a wireless sensor 161, which is disposed in a vicinity (near proximity) of the second high-priority wireless station 111.

The communication management resource 141 compares a power level 107 of receiving the wireless communications 101-1 at the wireless sensor 161 to a respective threshold level (such as WPTL) or a range about the threshold level value WPTL. The communication management resource 141 desires to maintain detected wireless power level 107 of receiving the wireless communications 101-1 in the range as illustrated by the graph 105. The control commands transmitted in the communications 145 can be configured to control a magnitude of second, subsequent wireless communications transmitted from the first wireless station to the mobile communication device 121. For example, the wireless base station 131 can be configured to transmit the second wireless communications 101-2 in accordance with the control commands received from the communication management resource 141 (management entity). In such an instance, the control commands ensure that the second wireless communications 101-2 do not cause wireless interference to the high-priority wireless station 111, which is in a vicinity (such as near proximity) of the wireless sensor 161. The subsequently transmitted commands communicated from the communication management resource 141 to the wireless base station 131 maintain a magnitude of the wireless power level 107 associated with wireless communications 101 at the wireless sensor 161 and corresponding wireless station 111 to be at or below a respective wireless power threshold level WPTL or within a respective range about the wireless power threshold level WPTL.

Referring again to FIG. 1, it is noted that the high-priority wireless station 111 may move about the network environment 100. Additionally, recall in FIG. 2 that the communication management resource 141 can be configured to transmit a control information 145-1 in communications 145 to the wireless base station 131 to control a wireless power level of the wireless base station 131 transmitting in the network environment 100. The control information 145-1 can be updated over time transmitted to the wireless base station 131. The wireless base station 131 corresponding communication management resource 140 can be configured to use the updated control information to determine how to control the wireless power level of transmitting any of the communications 101-1, 101-2, etc.

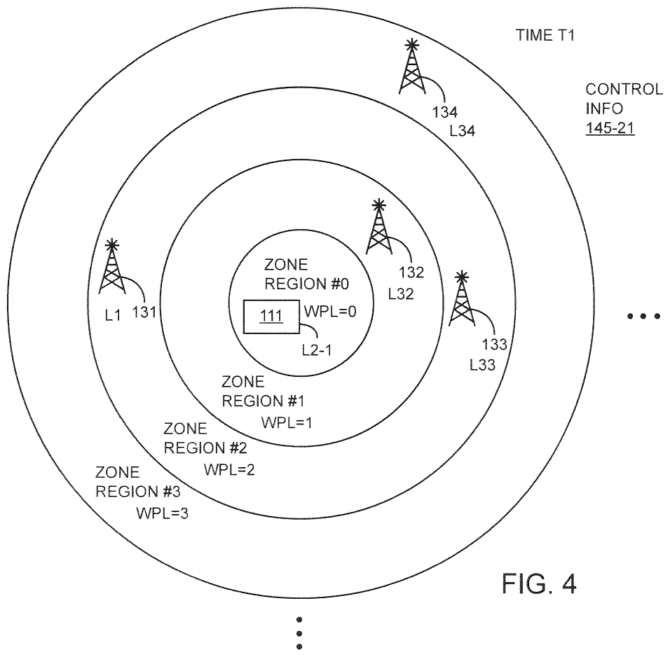

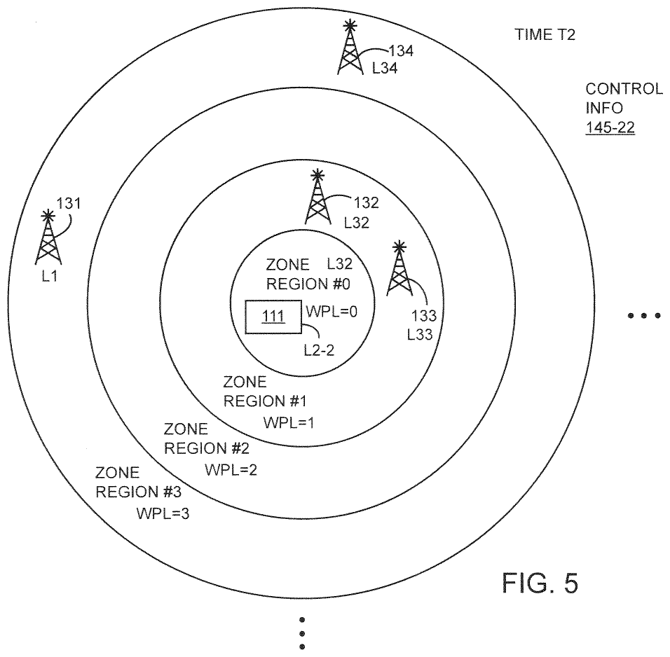

As an alternative to transmitting control information 145-1, the communication management resource 141 can be configured to generate control information 145-21 as shown in FIG. 4 and control information 145-22 in FIG. 5. As further discussed below, the wireless base station 131 can be configured to use such information over time to control transmission of wireless communications from the wireless base station 131 in a direction toward the communication device 121 and the high-priority wireless station 111.

More specifically, FIG. 4 is an example diagram illustrating a first instance of different zone regions and corresponding assigned wireless power level information used to control wireless transmission of communications in the network environment 100 as discussed herein.

In this example, the wireless base station 131 receives control information 145-21 at or around time T1. The communication management resource 141 generates the control information 145-21 based upon the current location L2-1 of the high-priority wireless station 111 at or around time T1.

In general, the control information 145-21 indicates different zone regions in the network environment 100, where each of the different zone regions is assigned a wireless power level value for wirelessly transmitting in the network environment 100.

In one example, the different zone regions as specified by the control information 145-21 include zone region #0, zone region #1, zone region #2, zone region #3, etc.

It is noted that each of the different zone regions in FIG. 4 accounts for a distance with respect to the wireless station 111 and corresponding path loss of transmitting wireless signals. For example, because of the nearness to the wireless station 111, no mobile communication devices in the zone region #0 are able to transmit over the wireless channel #1 use by the wireless station 111. Each successive concentric zone region further out from the core zone region #0 is assigned a higher wireless power level to transmit wireless communications from a wireless base station due to a higher amount of attenuation associated with wireless signals (which need to travel a further distance to reach zone region #0) further out from the zone region #0.

The zone region #0 is created based upon a current location L2-1 of the high-priority wireless station 111. It is noted that, although the wireless station 111 is disposed in the zone region #0, the high-priority wireless station 111 may not reside at the center of the zone region #0. In other words, the zone region #0 is arbitrarily chosen to include the location L2-1 associated with the wireless station 111. However, the location L2-1 of the wireless station 111 need not be located at a center of the zone region #0 to avoid advertising the location of the wireless station 111.

Each zone region in the control information 145-21 is assigned a different wireless power level transmitting wireless communications in the network environment 100.

For example, the zone region #0 is assigned a wireless power level of 0, because the high-priority wireless station 111 (such as incumbent entity) is present in the zone region #0. Setting of the wireless power level to 0 in the zone region #0 prevents any wireless stations in the zone region #0 from transmitting wireless communications that would interfere with the wireless station 111.

Zone region #1 is assigned a wireless power level of WPL1 (where WPL1>0). his means that any wireless stations in the zone region #1 are able to transmit over the wireless channel #1 at the wireless power level of WPL1. Any transmitted wireless communications at or below the wireless power level WPL1 by wireless stations in the zone region #1 are sufficiently attenuated such that those transmitted wireless communications do not interfere with the high-priority wireless station 111. In other words, the attenuation level is sufficiently high such that the wireless station 111 does not receive the transmitted wireless communications from zone region #1 above the wireless protection threshold level WPTL.

Zone region #2 is assigned a wireless power level of WPL2 (where WPL2>WPL1). This means that any wireless stations in the zone region #2 are able to transmit at or below the wireless power level of WPL2. Any transmitted wireless communications at or below the wireless power level WPL2 by wireless stations in the zone region #1 are sufficiently attenuated such that those transmitted wireless communications do not interfere with the high-priority wireless station 111. In other words, the attenuation level such wireless signals is sufficiently high such that the wireless station 111 does not receive the transmitted wireless communications from zone region #2 above the wireless protection threshold level WPTL.

Zone region #3 is assigned a wireless power level of WPL3 (where WPL3>WPL2). This means that any wireless stations in the zone region #3 are able to transmit at or below the wireless power level of WPL3. Any transmitted wireless communications at the wireless power level WPL3 by wireless stations in the zone region #3 are sufficiently attenuated such that those transmitted wireless communications do not interfere with the high-priority wireless station 111. In other words, the attenuation level is sufficiently high such that the wireless station 111 does not receive the transmitted wireless communications from zone region #3 above the wireless protection threshold level WPTL, and so on.

Further in this example, when determining the wireless power level at which to transmit the first wireless communications 101-1 from the wireless base station 131, assume that the wireless base station 131 detects that its location L1 at or around time T1 resides within the zone region #2 of the different zone regions as specified by the control information 145-21. As previously discussed, the wireless base station 131 can be configured to generate the wireless communications 101-1, including encoding the communications 101-1 for delivery to the mobile communication device 121. In response to the wireless base station 131 or corresponding communication management resource 140 detecting that the wireless base station 131 at location L1 resides in the zone region #2, the wireless base station 131 transmits the first wireless communications 101-1 at the second wireless power level WPL2 to the mobile communication device 121. Transmission of the first wireless communications 101-1 at the second wireless power level WPL2 supports wireless connectivity between the wireless base station 131 and the mobile communication device 121, but transmitting the wireless communications 101-1 at or below the wireless power level WPL2 assigned to the zone region #2 prevents wireless interference with/to the high-priority wireless station 111.

Further in this example, it is noted that the control information 145-21 can be transmitted from the communication management resource 141 to multiple wireless base stations operating in the network environment 100. For example, the communication management resource 141 can be configured to transmit the control information 145-21 to: i) the wireless base station 132 at location L32, ii) the wireless base station 133 at location L33, iii) the wireless base station 134 at location L34, and so on. In such an instance, the wireless base station 132 detects that it resides within the zone region #1 and limits its corresponding transmitted wireless communications to a wireless power level WPL1 assigned to the zone region #1; the wireless base station 133 detects that it resides within the zone region #2 and limits its corresponding transmitted wireless communications to a wireless power level WPL2 assigned to the zone region #2; the wireless base station 134 detects that it resides within the zone region #3 and limits its corresponding transmitted wireless communications to a wireless power level WPL3 assigned to the zone region #3, and so on.

FIG. 5 is an example diagram illustrating a second instance of different zone regions and corresponding assigned wireless power level information used to control wireless transmission of communications in the network environment as discussed herein.

It is noted that the high-priority wireless station 111 being protected in these examples may move about the network environment 100. In such an instance, the communication management resource 140 must update the control information over time.

For example, at or around time T2, the wireless station 111 resides at the location L2-2, which is a different location than L2-1. In response to the movement of the wireless station 111 from the location L2-1 to location L2-2, the communication management resource 141 produces the control information 145-22 based on the current location L2-2 of the wireless station 111.

Thus, FIG. 5 is an example diagram illustrating a second instance of different zone regions and corresponding assigned wireless power level information used to control wireless transmission of communications in the network environment as discussed herein.

In this example, the communication management resource 141 transmits the control information 145-22 to the wireless base station 131 at or around time T2. Accordingly, the wireless base station 131 receives control information 145-22 at or around time T2, such as when the high-priority wireless station 111 is disposed at location L2-2 or thereabout. As previously discussed, the communication management resource 141 generates the control information 145-22 based upon the current location L2-2 of the high-priority wireless station 111 and time T2.

In general, the control information 145-22 indicates different zone regions in the network environment 100, where each of the different zone regions is assigned a wireless power level value for wirelessly transmitting in the network environment 100.

In one example, the different zone regions as specified by the control information 145-22 include zone region #0, zone region #1, zone region #2, zone region #3, etc.

The zone region #0 is created based upon a current location L2-2 of the high-priority wireless station 111. It is noted that, although the wireless station 111 is disposed in the zone region #0, the high-priority wireless station 111 may not reside at the center of the zone region #0. In other words, the zone region #0 is arbitrarily chosen to include the location L2-2 and the wireless station 111. However, the location L2-2 of the wireless station 111 need not be located at a center of the zone region #0 to avoid advertising the location of the wireless station 111.

Each zone region in the control information 145-21 is assigned a different wireless power level of transmitting wireless communications in the network environment 100.

For example, the zone region #0 is assigned a wireless power level of 0, because the high-priority wireless station 111 (such as incumbent entity) is present in the zone region #0. Setting of the wireless power level to 0 in the zone region #0 prevents any wireless stations in the zone region #0 from transmitting wireless communications that would interfere with the wireless station 111.

Zone region #1 is assigned a wireless power level of WPL1 (where WPL1>0). This means that any wireless stations in the zone region #1 are able to transmit at the wireless power level of WPL1. Any transmitted wireless communications at or below the wireless power level WPL1 by wireless stations in the zone region #1 are sufficiently attenuated such that those transmitted wireless communications do not interfere with the high-priority wireless station 111. In other words, in one example, the attenuation level is sufficiently high such that the wireless station 111 does not receive the transmitted wireless communications from zone region #1 above the wireless protection threshold level WPTL.

Zone region #2 is assigned a wireless power level of WPL2 (where WPL2>WPL1). This means that any wireless stations in the zone region #2 are able to transmit at the wireless power level of WPL2. Any transmitted wireless communications at or below the wireless power level WPL2 by wireless stations in the zone region #2 are sufficiently attenuated such that those transmitted wireless communications do not interfere with the high-priority wireless station 111. In other words, in one example, the attenuation level is sufficiently high such that the wireless station 111 does not receive the transmitted wireless communications from zone region #2 above the wireless protection threshold level WPTL.

Zone region #3 is assigned a wireless power level of WPL3 (where WPL3>WPL2). This means that any wireless stations in the zone region #3 are able to transmit at the wireless power level of WPL3. Any transmitted wireless communications at the wireless power level WPL3 by wireless stations in the zone region #3 are sufficiently attenuated such that those transmitted wireless communications do not interfere with the high-priority wireless station 111. In other words, in one example, the attenuation level is sufficiently high such that the wireless station 111 does not receive the transmitted wireless communications from zone region #3 above the wireless protection threshold level WPTL, and so on.

Further in this example, when determining the wireless power level at which to transmit the first wireless communications 101-1 from the wireless base station 131, assume that the wireless base station 131 detects that its location L1 at or around time T2 resides within the zone region #3 of the different zone regions as specified by the control information 145-22. As previously discussed, the wireless base station 131 can be configured to generate the wireless communications 101-1, including encoding the communications 101-1 for delivery to the mobile communication device 121. In response to the wireless base station 131 or corresponding communication management resource 141 detecting that the wireless base station 131 at location L1 resides in the zone region #3 at or around time T2, the wireless base station 131 transmits the first wireless communications 101-1 at the third wireless power level WPL3 to the mobile communication device 121. Transmission of the first wireless communications 101-1 at or below the third wireless power level WPL3 supports wireless connectivity between the wireless base station 131 and the mobile communication device 121, but transmitting the wireless communications 101-1 at or below the wireless power level WPL3 assigned to the zone region #3 prevents wireless interference with/to the high-priority wireless station 111.

In a similar manner as previously discussed, with further reference to FIG. 1 and FIGS. 4 and 5, it is further noted that, subsequent to transmitting the first wireless communications 101-1, via further communications 145 from the communication management resource 141, feedback can be used to control a magnitude of wireless communications 101 transmitted by the wireless base station. In other words, the control information 145-1 and 145-2 may no longer be needed to control wireless power level transmissions from the wireless base stations.

For example, the wireless base station 131 may receive control commands from a management entity such as the communication management resource 141 monitoring the magnitude of receiving the transmitted first wireless communications 101-1 at a wireless sensor 161, which is disposed in a vicinity (near proximity) of the high-priority wireless station 111. The communication management resource 141 can be configured to compare a power level 107 of receiving the wireless communications 101-1 at the wireless sensor 161 to a respective threshold level (such as WPTL) or a range about the threshold level WPTL.

As previously discussed, the communication management resource 141 desires to maintain detected wireless power level 107 of receiving the wireless communications 101-1 in the range as illustrated by the graph 105. The control commands transmitted in the communications 145 can be configured to control a magnitude of second, subsequent wireless communications transmitted from the wireless base station 131 to the mobile communication device 121. For example, the wireless base station 131 can be configured to transmit the second wireless communications 101-2 in accordance with the control commands (specifying whether to increase or decrease the power level transmitting communications 101) received from the communication management resource 141 (management entity). In such an instance, the control commands from the communication management resource 141 ensure that the second wireless communications 101-2 do not cause wireless interference to the high-priority wireless station 111, which is in a vicinity (such as near proximity) of the wireless sensor 161. Via the feedback loop, the subsequently transmitted commands communicated from the communication management resource 141 to the wireless base station 131 maintain a magnitude of the wireless power level 107 associated with wireless communications 101 at the wireless sensor 161 to be at or below a respective wireless power threshold level WPTL or within a respective range about the wireless power threshold level WPTL.

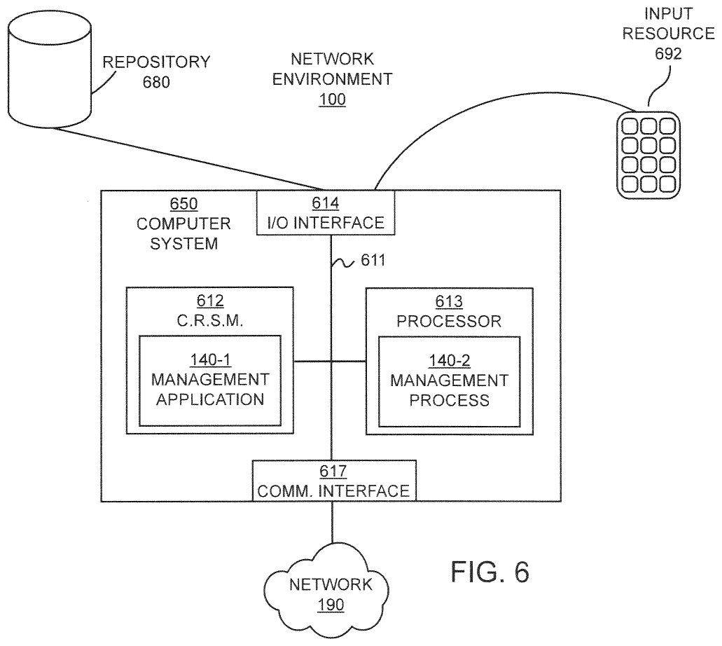

FIG. 6 is an example block diagram of a computer system for implementing any of the operations as discussed herein.

Note that any of the resources (such as communication management resource 140, communication device 121, communication management resource 141, wireless base station 131, etc.) as discussed herein can be configured to include computer processor hardware and/or corresponding executable instructions to carry out the different operations as discussed herein.

For example, as shown, computer system 650 of the present example includes interconnect 611 coupling computer readable storage media 612 such as a non-transitory type of media, or computer readable storage hardware (which can be any suitable type of resource in which digital information can be stored and or retrieved), a processor 613 (computer processor hardware), I/O interface 614, and a communications interface 617.

I/O interface(s) 614 supports connectivity to repository 680 and input resource 692.

Computer readable storage medium 612 such as computer readable hardware can be any hardware storage device such as memory, optical storage, hard drive, floppy disk, etc. In one example, the computer readable storage medium 612 stores instructions and/or data.

As shown, computer readable storage media 612 can be encoded with communication management application 140-1 in a respective wireless station to carry out any of the operations as discussed herein.

During operation of one example, processor 613 accesses computer readable storage media 612 via the use of interconnect 611 in order to launch, run, execute, interpret or otherwise perform the instructions in management application 140-1 stored on computer readable storage medium 612. Execution of the communication management application 140-1 produces communication management process 140-2 to carry out any of the operations and/or processes as discussed herein.

Those skilled in the art will understand that the computer system 650 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 650 may reside at any location or can be included in any suitable resource in any network environment to implement functionality as discussed herein.

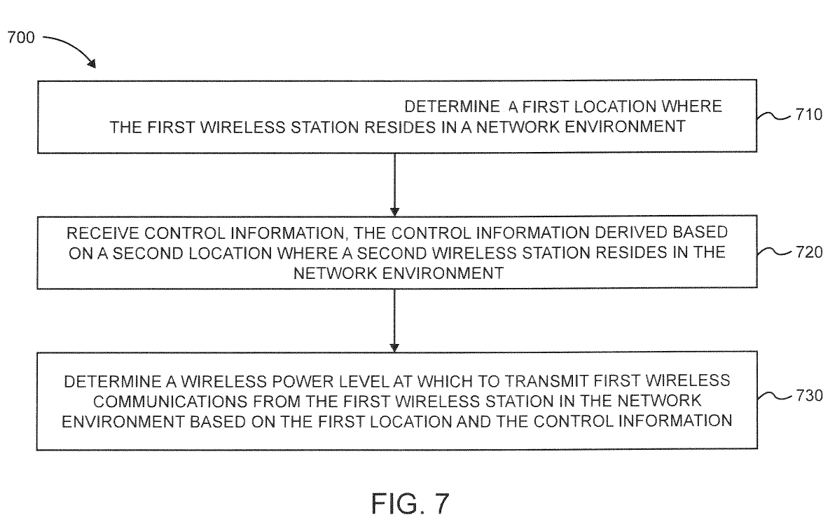

Functionality supported by the different resources will now be discussed via flowchart 700 in FIG. 7. Note that the steps in the flowchart below can be executed in any suitable order.

FIG. 7 is a flowchart 700 illustrating an example method according to examples herein. Note that there will be some overlap with respect to concepts as discussed above.

In processing operation 710, the wireless base station 131 determines a first location L1 where the wireless base station 131 resides in a network environment 100.

In processing operation 720, the wireless base and receives control information 145-1. In one example, the control information 145-1 is derived based at least in part on a second location L2 where a high priority wireless station 111 resides in the network environment 100.

In processing operation 730, the wireless base station 131 (such as including the communication management resource 140) determines a wireless power level XMITPWR(131) at which to transmit first wireless communications 101-1 or other subsequent wireless communications from the wireless base station 131 based on the first location L1 and the received control information 145-1.

Note again that techniques herein are well suited to provide improved wireless connectivity amongst wireless stations and lower wireless interference to high priority entities. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
at a first wireless station:
determining a first location where the first wireless station resides in a network environment;
receiving control information, the control information derived based on a second location where a second wireless station resides in the network environment, the second wireless station assigned a higher priority in a tiered hierarchy than the first wireless station; and
determining a wireless power level at which to transmit first wireless communications from the first wireless station in the network environment based on the first location and the control information.

2. The method as in claim 1, wherein the control information indicates a wireless power threshold level value WPTL, the wireless power threshold level value WPTL being a wireless threshold level selected to protect the second wireless station from wireless interference caused by the first wireless station transmitting the first wireless communications.

3. The method as in claim 2, wherein determining the wireless power level includes:
estimating a path loss value PLV based on the location of the first wireless station with respect to a third location as specified by the control information, the third location different than the second location, the estimated path loss value PLV representing an estimated path loss between the first location and the second location; and
calculating the wireless power level at which to transmit the first wireless communications based on a combination of the estimated path loss as indicated by the path loss value PLV and the wireless power threshold level WPTL.

4. The method as in claim 3, wherein the calculated wireless power level is a wireless power level TxPWR at which the first wireless station transmits the first wireless communications;
wherein TxPWR=WPTL−TxANTGAIN−PLV; and
wherein TxANTGAIN represents a gain associated with antenna hardware at the first wireless station transmitting the first wireless communications.

5. The method as in claim 1 further comprising:
transmitting the first wireless communications at the determined wireless power level from the first wireless station, the first wireless communications encoded for delivery to a third wireless station in the network environment; and
wherein transmission of the first wireless communications at the determined wireless power level protects the second wireless station from wireless interference caused by the first wireless station transmitting the first wireless communications.

6. The method as in claim 5 further comprising:
subsequent to transmitting the first wireless communications, receiving control commands from a management entity monitoring the magnitude of receiving the transmitted first wireless communications at a wireless sensor in a vicinity of the second wireless station, the control commands controlling a magnitude of second wireless communications transmitted from the first wireless station to the third wireless station.

7. The method as in claim 6 further comprising:
at the first wireless station, transmitting the second wireless communications in accordance with the control commands received from the management entity.

8. The method as in claim 1, wherein the received control information indicates different zone regions in the network environment, each of the different zone regions assigned a wireless power level value for wirelessly transmitting in the network environment.

9. The method as in claim 8, wherein the different zone regions as specified by the control information include a first zone region assigned a first wireless power level and a second zone region assigned a second wireless power level.

10. The method as in claim 9, wherein determining the wireless power level at which to transmit the first wireless communications includes:
detecting that the first location resides within the second zone region.

11. The method as in claim 10 further comprising:
in response to detecting that the first wireless station resides in the second zone region, transmitting the first wireless communications at the second wireless power level to the third wireless station.

12. The method as in claim 11, wherein transmitting the first wireless communications at the second wireless power level supports wireless connectivity between the first wireless station and the third wireless station but prevents wireless interference with the second wireless station from being above a threshold level.

13. A system comprising:
communication management hardware operative to:
determine a first wireless station resides in a network environment;
receive control information, the control information derived based on a second location where a second wireless station resides in the network environment, the second wireless station assigned a higher priority in a tiered hierarchy than the first wireless station; and
determine a wireless power level at which to transmit first wireless communications from the first wireless station in the network environment based on the first location and the control information.

14. The system as in claim 13, wherein the control information indicates a wireless power threshold level value WPTL, the wireless power threshold level value WPTL being a wireless threshold level selected to protect the second wireless station from wireless interference caused by the first wireless station transmitting the first wireless communications.

15. The system as in claim 13, wherein the communication management hardware is further operative to:
estimate a path loss value PLV based on the location of the first wireless station with respect to a third location as specified by the control information, the third location different than the second location, the estimated path loss value PLV representing an estimated path loss between the first location and the second location; and
calculate the wireless power level at which to transmit the first wireless communications based on a combination of the estimated path loss as indicated by the path loss value PLV and the wireless power threshold level WPTL.

16. The system as in claim 13, wherein the calculated wireless power level is wireless power level TxPWR at which the first wireless station transmits the first wireless communications;
wherein TxPWR=WPTL−TxANTGAIN−PLV; and
wherein TxANTGAIN represents a gain associated with antenna hardware at the first wireless station transmitting the first wireless communications.

17. The system as in claim 13, wherein the communication management hardware is further operative to:
transmit the first wireless communications at the determined wireless power level from the first wireless station, the first wireless communications encoded for delivery to a third wireless station in the network environment; and
wherein transmission of the first wireless communications at the determined wireless power level is operative to protect the second wireless station from interference caused by the first wireless station transmitting the first wireless communications from being above a threshold level.

18. The system as in claim 17, wherein the communication management hardware is further operative to:
subsequent to transmitting the first wireless communications, receive control commands from a management entity monitoring the magnitude of receiving the transmitted first wireless communications at a wireless sensor in a vicinity of the second wireless station, the control commands controlling a magnitude of second wireless communications transmitted from the first wireless station to the third wireless station.

19. The system as in claim 18, wherein the communication management hardware is further operative to:
at the first wireless station, transmitting the second wireless communications in accordance with the control commands received from the management entity.

20. The system as in claim 13, wherein the received control information indicates different zone regions in the network environment, each of the different zone regions being assigned a wireless power level value for wirelessly transmitting in the network environment.

21. The system as in claim 20, wherein the different zone regions as specified by the control information include a first zone region assigned a first wireless power level and a second zone region assigned a second wireless power level.

22. The system as in claim 21, wherein the communication management hardware is further operative to:
detect that the first location resides within the second zone region.

23. The system as in claim 22, wherein the first wireless communications are encoded for delivery to a third wireless station in the network environment, the communication management hardware further operative to:
in response to detecting that the first wireless station resides in the second zone region, transmit the first wireless communications at the second wireless power level to the third wireless station.

24. The system as in claim 23, wherein transmitting the first wireless communications at the second wireless power level supports wireless connectivity between the first wireless station and the third wireless station but prevents wireless interference with the second wireless station from being above a threshold level.

25. Computer-readable storage hardware having instructions stored thereon, the instructions, when carried out by computer processor hardware, cause the computer processor hardware to:
determine a first location where a first wireless station resides in a network environment;
receive control information, the control information derived based on a second location where a second wireless station resides in the network environment, the second wireless station assigned a higher priority in a tiered hierarchy than the first wireless station; and
determine a wireless power level at which to transmit first wireless communications from the first wireless station in the network environment based on the location of the first wireless station and the control information.
